(19) United States
(12) Patent Application Publication
(10) Pub. No.: US 2021/0192185 A1
(43) Pub. Date: Jun. 24, 2021

(54) IMAGE STORAGE

(71) Applicant: HEWLETT-PACKARD DEVELOPMENT COMPANY, L.P., Houston, TX (US)

(72) Inventors: Qian LIN, Palo Alto, CA (US); Carlos Alberto CEJA LIMON, Jalisco (MX)

(73) Assignee: HEWLETT-PACKARD DEVELOPMENT COMPANY, L.P., Houston, TX (US)

(21) Appl. No.: 16/074,374

(22) PCT Filed: Dec. 15, 2016
(86) PCT No.: PCT/US2016/067058

§ 371 Date: Jul. 31, 2018

(51) Int. Cl. G06K 9/00; G06T 7/20

(52) U.S. Cl. CPC G06K 9/00261; G06K 9/00718; G06K 2009/00738; G06K 9/00288; G06T 7/20; G06K 9/00315

(57) ABSTRACT

An example is described in which an event is detected in a video stream. In addition, a representative frame is selected for the event. The representative frame is stored. Other frames corresponding to the event are discarded.

### BACKGROUND

A camera may capture images. In some examples, the camera may capture video, for example, by capturing a plurality of images at periodic intervals. The images may be captured at a frame rate high enough to create the perception of smooth motion, such as 24 frames per second (fps), 25 fps, 30 fps, 50 fps, 60 fps, or the like. As used herein, the term “frame” refers to a single progressive scan image or a pair of interlace fields. Alternatively, or in addition, the images may be captured at a slower rate that may create the perception of jerky motion, such as one frame every five seconds, one frame every two seconds, one fps, two fps, five fps, or the like. The captured images may include any of various numbers of pixels. The resolution of the images may be specified by the number of pixels in one of the dimensions and the aspect ratio. For example, the images may include 480, 576, 720, 960, 1080, 1440, or the like pixels in a shorter dimension or 3840 (4K), 7680 (8K), or the like pixels in a longer dimension and an aspect ratio of 4:3, 16:9, or the like.

### BRIEF DESCRIPTION OF THE DRAWINGS

FIG. 1 is a block diagram of an example system to store captured images efficiently.

FIG. 2 is a block diagram of another example system to store captured images efficiently.

FIG. 3 is a flow diagram of an example method to store video frames efficiently.

FIG. 4 is a flow diagram of another example method to store video frames efficiently.

FIG. 5 is a block diagram of an example computer-readable medium including instructions that cause a processor to store images efficiently.

FIG. 6 is a block diagram of another example computer-readable medium including instructions that cause a processor to store images efficiently.

### DETAILED DESCRIPTION

Using a higher frame rate or a higher resolution may make it easier for a viewer to understand what is occurring in a video or recognize faces. However, videos with higher frame rates or higher resolutions may require more storage space. In some situations, a camera may operate continuously or for long periods. For example, a home or business may include a plurality of security cameras, and each security camera may operate continuously. In an example, a camera with a resolution of 1280×960 pixels may generate 3.546 megabytes (MB) of data for a ten-second video. Five cameras operating continuously for a week may generate over one terabyte (TB) of data. Thus, large amounts of storage space may be used when operating cameras continuously or when operating large numbers of cameras. Alternatively, video may be periodically deleted to free space, but may not be available later if needed.

In some examples, the camera or processing after recording may detect motion, and portions of the video without motion may be discarded. However, video with uninteresting motion may be retained unnecessarily. For example, random objects, such as a balloon, a tree blowing in the wind, etc., may be detected as motion. In addition, much of the recording may be of a trusted individual who frequently appears within view of the camera. Moreover, in some examples, the video may be used for identifying the individuals in the video, and much of the video may be unnecessary or unhelpful for identifying the individuals. Accordingly, the video could be stored more efficiently by discarding additional unnecessary elements of the video.

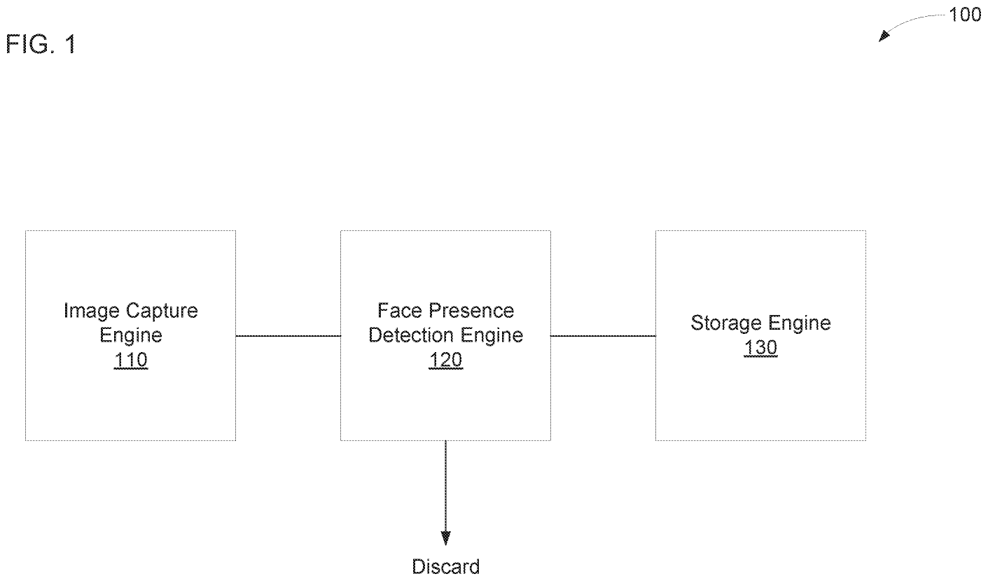

FIG. 1 is a block diagram of an example system 100 to store captured images efficiently. The system 100 may include an image capture engine 110. As used herein, the term “engine” refers to hardware (e.g., a processor, such as an integrated circuit or other circuitry) or a combination of software (e.g., programming such as machine- or processor-executable instructions, commands, or code such as firmware, a device driver, programming, object code, etc.) and hardware. Hardware includes a hardware element with no software elements such as an application specific integrated circuit (ASIC), a Field Programmable Gate Array (FPGA), etc. A combination of hardware and software includes software hosted at hardware (e.g., a software module that is stored at a processor-readable memory such as random access memory (RAM), a hard-disk or solid-state drive, resistive memory, or optical media such as a digital versatile disc (DVD), and/or executed or interpreted by a processor), or hardware and software hosted at hardware. The image capture engine 110 may detect motion. For example, the image capture engine 110 may detect motion in images sensed by an image sensor, or the image capture engine 110 may include a sensor independent of the image sensor to detect motion. The image capture engine 110 may capture an image based on the motion.

The system 100 may include a face detection engine 120. The face detection engine 120 may determine whether a face is present in the image. In some examples, the face detection engine 120 may determine whether the face is present in the image without attempting to identify the face. For example, the face detection engine 120 may detect whether facial features are present in the image. The system 100 may include a storage engine 130. Based on a determination a face is present, the storage engine 130 may store the image. For example, the face detection engine 120 may indicate to the storage engine 130 which images should be stored. Alternatively, or in addition, the face detection engine 120 may send images that should be stored to the storage engine 130 and not send images that should not be stored. The face detection engine 120 may determine which images should be stored and should not be stored based on the determination of whether a face is present.

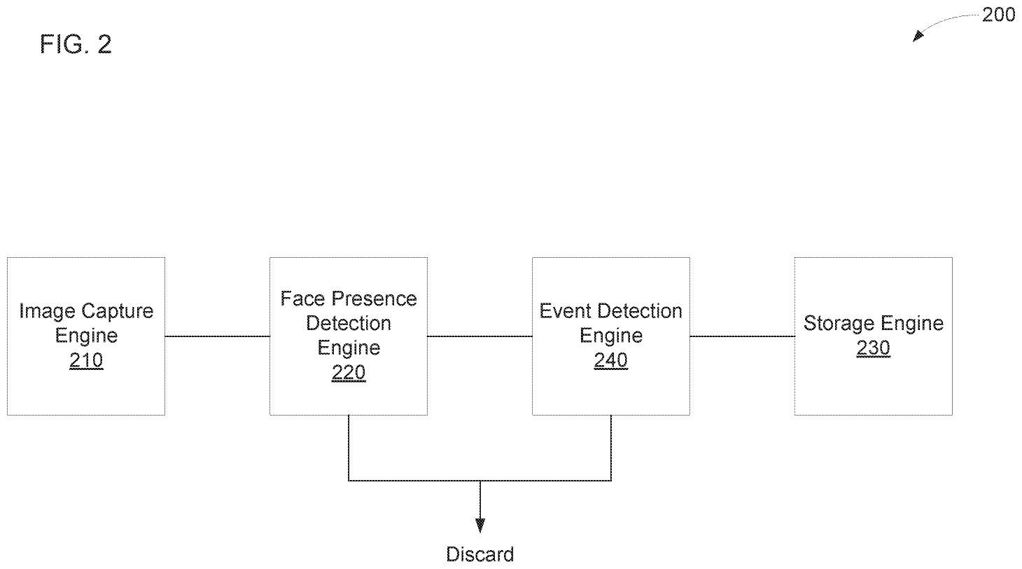

FIG. 2 is a block diagram of another example system 200 to store captured images efficiently. The system 200 may include an image capture engine 210. The image capture engine 210 may detect motion. For example, the image capture engine 210 may include a passive infrared detector to detect motion. Alternatively, or in addition, the image capture engine 210 may compare a plurality of images to determine whether there is motion in the images. In some examples, the image capture engine 210 may be unable to detect motion. Detecting motion may limit the amount of data that needs to be analyzed by the face detection engine 220.

Based on the motion, the image capture engine 210 may capture an image. The image capture engine 210 may capture a single image based on the motion, may capture video at a high frame rate (e.g., a frame rate high enough to create the perception of smooth motion), may capture video at a slower frame rate, or the like. For example, the image capture engine 210 may begin capturing images when motion is detected and may continue capturing images for a predetermined time, until the motion stops, or the like. In an example, a single image may be detected each time motion is detected. As used herein, the term “capture” means to detect the image with a sensor and store the image at least temporarily. For example, the images may be stored temporarily for further analysis.

The system 200 may include a face detection engine 220. The face detection engine 220 may determine whether a face is present in the image. The face detection engine 220 may be located locally with the image capture engine 210 or may be located remotely from the image capture engine 210. For example, the image capture engine 210 may upload the image to a server, which may include the face detection engine 220. The face detection engine 220 may analyze the image to determine whether facial features are present. For example, the face detection engine 220 may determine a score indicative of how likely it is that a portion of the image corresponds to a face. The face detection engine 220 may compare the score to a threshold to determine whether the portion corresponds to a face.

The system 200 may include a storage engine 230. The storage engine 230 may store the image based on the determination a face is present. For example, the face detection engine 220 may indicate to the storage engine 230 whether to store the image, or the face detection engine 220 may transmit the image to the storage engine 230 if it should be stored and not transmit the image if it should not be stored. The storage engine 230 may save the image to a persistent computer-readable medium. In an example, the storage engine 230 may store the image if a face is present in the image and not store the image if the face is not present in the image. Accordingly, the system 200 may reduce the amount of storage used by discarding images without faces present.

In some examples, the storage engine 230 may discard additional images if they have the same face as a previously captured image. For example, the face detection engine 220 may also identify the face in images that it analyzes. Identification of faces may also be referred to as face recognition. The face detection engine 220 may compare the identified face to faces identified in previous images. The face detection engine 220 may determine whether the current and previous face match a same identity, whether a similarity between the current and previous face is greater than a threshold, or the like. If a match is found, the face detection engine 220 or the storage engine 230 may discard the current image or a previously stored image. Accordingly, the system 200 may significantly reduce the amount of storage used by preventing redundant storage of images containing a particular face. In some examples, the face detection engine 220 may provide near real-time feedback if an unauthorized face is detected.

The face detection engine 220 may determine a quality of the face in the image for face identification purposes. A face may be of better quality if it is more likely to be identified. When deciding whether to keep the current image or a previously stored image, the face detection engine 220 may determine which image has a better quality face. The face detection engine 220 or the storage engine 230 may store the image with the better quality face and discard the image with the worse quality face. In some examples, the storage engine 230 may store the identity of the face (e.g., a name, identification number, etc.), information usable to compare the face to faces in future images (e.g., a mathematical or numerical description of the face, etc.), or the like in association with the image.

Various parameters may be included when determining the quality of the face. In an example, the face detection engine 220 may determine the quality of the face based on an angle of the face. For example, the face detection engine 220 may determine a roll, pitch, or yaw of the face, a normal vector to the face in three-dimensional space, or the like to determine an angle of the face. The quality of the face may be better when the image includes a full frontal view of the face. In an example, the face detection engine 220 may determine a sharpness of the face. For example, the sharpness may depend on the distance of the face from the camera, whether the face is in focus, etc.

In an example, the face detection engine 220 may determine the quality of the face based on a pose of the face. For example, a face may be more identifiable if the pose of the face matches the pose of an enrolled face used as a reference for identifying faces. In some examples, enrolled faces may include a neutral facial expression, open eyes, or the like. Accordingly, the face detection engine 220 may determine the quality of the face based on whether the face in the image includes a neutral facial expression, open eyes, etc. In some examples, the face detection engine 220 may determine the quality based on the brightness of the face. For example, a face may be less identifiable if it oversaturated (e.g., too bright) or undersaturated (e.g., too dark).

The face detection engine 220 may use any combination of the parameters to create a quality score. The face detection engine 220 may compare the quality scores of the faces in two images to determine which image is better quality and should be kept. In some examples, there may be multiple faces in an image. In an example, the face detection engine 220 may combine the quality scores for the multiple faces (e.g., by computing an average, median, maximum, or the like of the quality scores), and the face detection engine 220 may determine which image to keep based on which has the better combined score. Alternatively, or in addition, the face detection engine 220 may keep a current image if the quality score of any face is better than the corresponding score in the previous image and may discard a previous image if the quality score of every face is worse than in some other image. For example, the face detection engine 220 may include, for each face, the image with the best quality score for that face.

The system 200 may include an event detection engine 240. The event detection engine 240 may distinguish events in sets of images received from the image capture engine 210. The storage engine 230 may store an image containing a face for each event. The storage engine 230 may discard additional images for the event but may store an additional image if another event is detected. For example, the storage engine 230 may store the image containing the best quality face for each event even if that face has appeared in a previous image associated with a previous event.

In an example, the event detection engine 240 may decide whether a current image is part of the same event as a previous image based on a time between the images. The time may be the time between the capturing of each image, the time between receipt of each image by the event detection engine 240, or the like. For example, the storage engine 230 may store the time for each event, such as a start time and an end time for that event. If the difference between the time for the current image and the end time for the most recent event is less than a threshold, the event detection engine 240 may determine that the current image is part of the most recent event. In such a situation, the face detection engine 220 may determine whether to keep the current image based on the other images in the most recent event, and the storage engine 230 may update the end time for the event. If the time difference is greater than the threshold, the storage engine 230 may store the current image as a new event and may store the time for the current image as the start and end time for the new event. In some examples, the storage engine 230 may store the identity of the face in the current image, information usable to compare the face to faces in future images, etc. in association with the new event. As used herein, the term “less than” includes strictly less than or less than or equal to, and the term “greater than” includes strictly greater than or greater than or equal to.

The event detection engine 240 may decide whether a current image is part of the same event as a previous image based on the number of faces in each image or the similarity of the faces in the current and the previous image. For example, the event detection engine 240 may decide a new event is occurring if the number of faces changes. In an example, the event detection engine 240 may decide a new event is occurring if the number of faces increases but not if the number of faces decreases. The event detection engine 240 may also, or instead, decide a new event is occurring if the similarity between a face in the current image and a face in a previous image is less than a threshold. In an example, the storage engine 230 may store the current image as a new event if there is a new face in the image or if someone leaves the image. In some examples, the event detection engine 240 may a decide a new event is occurring if the time between images is greater than a threshold, the number of faces is different, or the similarity of faces between images is less than a threshold and may decide a previous event is continuing if none of these indications of a new event is true. A camera running continuously for a week and storing a representative image for each event may detect hundreds of events and occupy tens of megabytes of storage.

In an example, the event detection engine 240 may determine which images to include when the storage engine 230 is storing video. Storing all images in which a face is detected may still result in omission of relevant frames. For example, a person may initially appear in a first image, but the person's face may not be detectable until a second, later image. In an example, the face may have been detected in a current image and a previous image but not detected in interstitial images captured between the previous image and the current image. The event detection engine 240 may determine if the time between the previous image and the current image is less than a threshold, and the storage engine 230 may store the interstitial images based on the time being less than the threshold. The event detection engine 240 may also determine how many images to store before the face was initially detected or after the face was last detected. The event detection engine 240 may decide to store images beginning with when motion was initially detected and ending with when motion was last detected, may decide to store a first predetermined number of images before the face was initially detected and a second predetermined number of images after the face was last detected, or the like. The event detection engine 240 may decide to store the lesser of the first predetermined number of images and the number of images since motion was initially detected as well as the lesser of the second predetermined number of images and the number of images until motion was last detected.

The face detection engine 220 may use a whitelist of trusted faces to determine which images to store. For example, the face detection engine 220 may discard an image containing solely faces on the whitelist or discard an image in which any face is on the whitelist. The face detection engine 220 may store an image in which any face is not on the whitelist or in which no faces are on the whitelist. In an example, the face detection engine 220 may determine whether to store the image based on whether any or all of the faces are known faces in a reference set and may not separately compare the identity of the face to the whitelist. Alternatively, or in addition, the storage engine 230 may store different numbers of images for unknown and known faces or untrusted and trusted faces. For example, the storage engine 230 may store a plurality of images for an unknown or untrusted face (e.g., a full video with all images of the unknown or untrusted face) but store a single image of a known or trusted face.

In an example, the user may adjust settings that determine how many images to store. For example, the user may select whether to store a representative image for each event or a video of each event. The user may also, or instead, select whether known and unknown or trusted and untrusted faces should be treated differently. In an example, the storage engine 230 may store video of events for a first period of time and store a representative image of each event for a second period of time or indefinitely. For example, video may be kept for 24 hours, 48 hours, or the like, and a representative image may be kept for one month, two months, three months, six months, one year, or the like. The first and second periods of time may be predetermined or user specified.

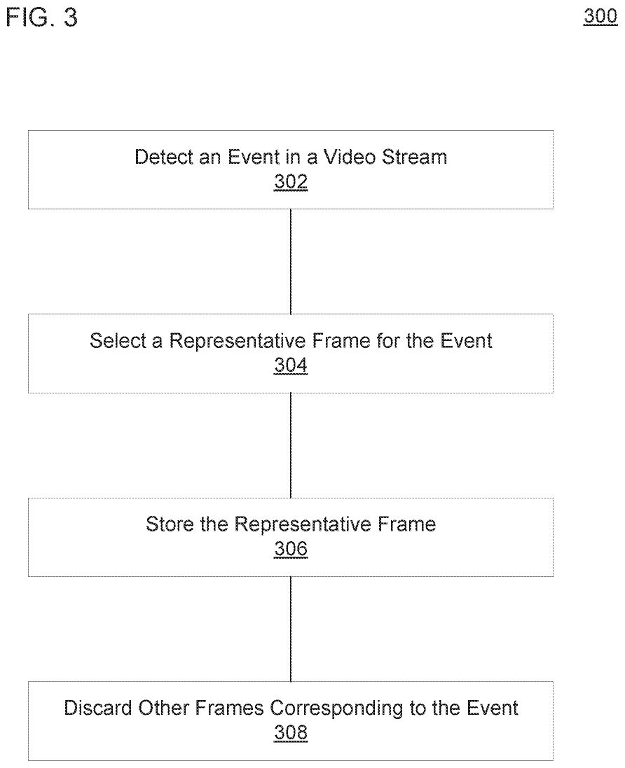

FIG. 3 is a flow diagram of an example method 300 to store video frames efficiently. A processor may perform the method 300. At block 302, the method 300 may include detecting an event in a video stream. For example, a frame of the video stream may be analyzed, or a series of frames may be analyzed to determine whether an event is occurring. Detecting the event may include distinguishing the particular event from other events occurring in the video (e.g., events before, after, or overlapping in time with the particular event). Detecting the event may include detecting how many or which faces are in the frames, detecting frames in which a person or object (e.g., vehicle, portable object, etc.) is in a particular location (e.g., near a valuable object, near a door or security device, in a cordoned off area or beyond a barrier, etc.), detecting frames in which a person or object is moving atypically or rapidly, or the like.

Block 304 may include selecting a representative frame for the event. The representative frame may be a frame that has more information than other frames corresponding to the event. For example, the representative frame may include a frame with a most identifiable face, a frame in which a person's or an object's location has reached an extreme (e.g., nearest a valuable object, nearest a door or security device, furthest beyond a barrier, etc.), a frame in which a person interacts with an object or another person, a frame in which a person's or an object's movement has reached an extreme, a frame in which a person's or an object's direction or speed changes, or the like. The representative frame may be selected to maximize a particular type of information, maximize multiple types of information, or the like. A representative image may be selected for each type of information, or a single representative image may be selected for multiple types of information. In an example, there may be a single image selected per event.

At block 306, the method 300 may include storing the representative frame. For example, the representative frame may be saved to a persistent computer-readable medium. Block 308 may include discarding other frames corresponding to the event. The other frames may include less information than the representative frame or redundant information, so discarding the other frames may reduce the amount of storage space used with limited loss of information. In an example, the event detection engine 240 of FIG. 2 may detect the event; the face detection engine 220 may select a representative frame; the storage engine 230 may store the representative frame; and the face detection engine 220 or the storage engine 230 may discard the other frames.

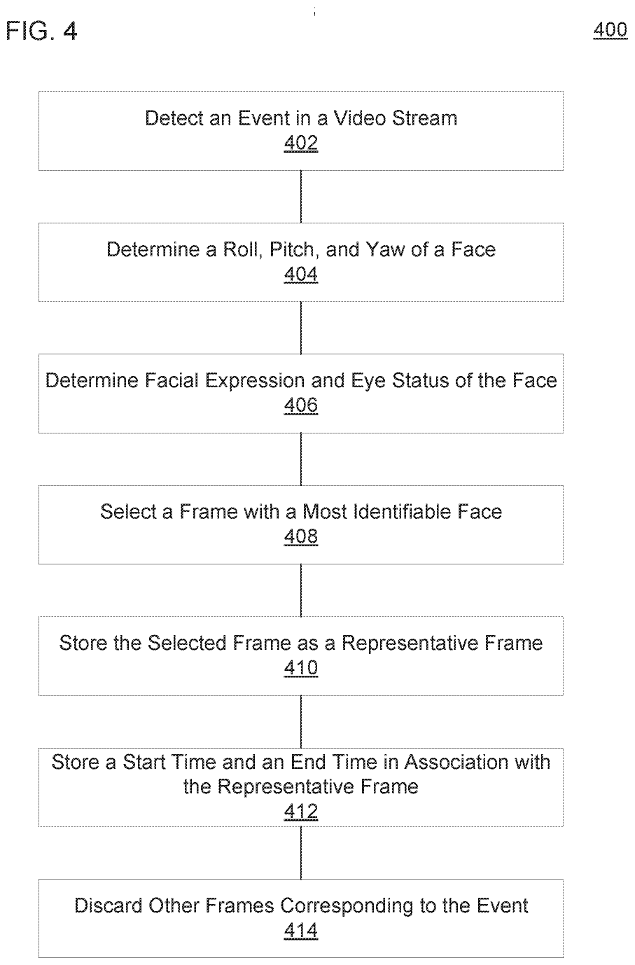

FIG. 4 is a flow diagram of another example method 400 to store video frames efficiently. A processor may perform the method 400. At block 402, the method 400 may include detecting an event in a video stream. In an example, detecting the event may include detecting a face in the video stream. In some examples, events may be distinguished from one another based on how many faces are in various frames of the video stream, based on how similar the faces are in various frames of the video stream, or the like. Detecting the event in the video stream may also, or instead, be based on the existence of motion in the video stream, based on the position or motion of people or objects in the video stream (e.g., characteristics of their motion, such as velocity, acceleration, etc.), or the like.

Block 404 may include determining a roll, pitch, or yaw of a face in a plurality of frames. For example, features of the face may be detected. The features may include eyes, nose, ears, mouth, eyebrows, an outline of the face, or the like. The roll, pitch, or yaw of the face may be determined based on the relative positions, distance (e.g., foreshortening), obscuring, or the like of the facial features. The roll, pitch, or yaw may be determined relative to a direction that would be faced by an upright face facing the camera that captured the video stream.

Block 406 may include determining a facial expression and an eye status of the face. Determining the facial expression may include determining whether the facial expression matches a facial expression of enrolled faces (e.g., a predetermined facial expression mandated for enrolled faces, a most common facial expression for enrolled faces, or the like). For example, determining the facial expression may include determining whether the facial expression is neutral without determining the particular facial expression if the facial expression is not neutral. In some examples, determining the facial expression may include determining the particular facial expression if the facial expression is not neutral. Determining the eye status may include determining whether the eyes of the face are open or closed.

At block 408, the method 400 may include selecting a frame with a most identifiable face. A face may be selected as most identifiable if the characteristics of the image of the face make it more likely to match an enrolled face than any other image of the face in the video stream (e.g., more likely than any other frame corresponding to the event). The most identifiable face may be selected based on the roll, pitch, or yaw of the face. For example, an upright, forward-facing face may be more identifiable than other faces, such as when the enrolled faces are upright and forward facing. The most identifiable face may be selected based on the facial expression (e.g., whether the facial expression matches an enrolled facial expression, such as a neutral facial expression). The most identifiable facial expression may also, or instead, be selected based on whether the eyes are open. In some examples, the most identifiable face may be selected based on a sharpness or a brightness of the face in the frame. The most identifiable face may be selected based on a combination of equally weighted or differently weighted criteria.

At block 410, the method 400 may include storing the selected frame as a representative frame. For example, the selected frame may be saved to a persistent computer-readable medium. A single selected frame may be stored for each event, or a plurality of representative frames may be stored for each event (e.g., a representative frame for each face in the event or the like).

Block 412 may include storing a start time and an end time in association with the representative frame. For example, the stored representative frames may be organized by events, and information about each event may be stored with the representative frames. The information about the event may include a start time, such as a first frame in which the event is detected or an earlier frame determined to be the start time when the event is detected. The information about the event may include an end time, which may be determined by checking each frame to determine if the event is continuing and setting the end time to the last frame in which the event was detected. The start time and end time may be determined by evaluating a plurality of frames together or by evaluating each frame individually, such as when that frame is received. In some examples, the information about the event may include the identities of faces detected during the event, information usable to compare the faces to faces in future frames, or the like.

At block 414, the method 400 may include discarding other frames corresponding to the event. For example, the discarding may include discarding frames containing redundant or less identifiable faces compared to the representative frame. Discarding the other frames may include discarding all but a single frame per event, discarding all but a small plurality of frames per event (e.g., all but one per face, all but a few per face, etc.), or the like. In an example, referring to FIG. 2, the event detection engine 240 may perform block 402; the face detection engine 220 may perform blocks 404, 406, 408, or 414; and the storage engine 230 may perform blocks 410, 412, or 414.

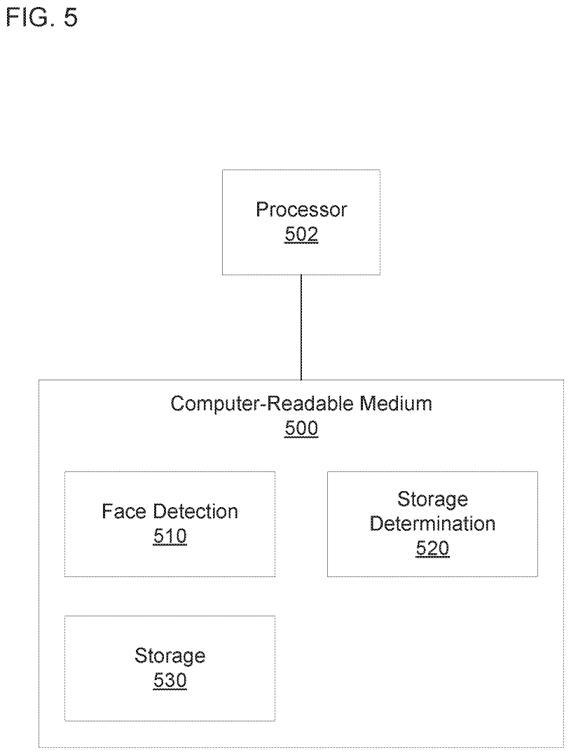

FIG. 5 is a block diagram of an example computer-readable medium 500 including instructions that, when executed by a processor 502, cause the processor 502 to store images efficiently. The computer-readable medium 500 may be a non-transitory computer readable medium, such as a volatile computer readable medium (e.g., volatile RAM, a processor cache, a processor register, etc.), a non-volatile computer readable medium (e.g., a magnetic storage device, an optical storage device, a paper storage device, flash memory, read-only memory, non-volatile RAM, etc.), and/or the like. The processor 502 may be a general purpose processor or special purpose logic, such as a microprocessor, a digital signal processor, a microcontroller, an ASIC, an FPGA, a programmable array logic (PAL), a programmable logic array (PLA), a programmable logic device (PLD), etc.

The computer-readable medium 500 may include a face detection module 510. As used herein, a “module” (in some examples referred to as a “software module”) is a set of instructions that when executed or interpreted by a processor or stored at a processor-readable medium realizes a component or performs a method. The face detection module 510 may include instructions that, when executed, cause the processor 502 to determine whether a face is present in an image. The face detection module 510 may cause the processor 502 to determine whether facial features are present in the image and determine whether the face is present based on the facial features.

The computer-readable medium 500 may include a storage determination module 520. The storage determination module 520 may cause the processor 502 to determine whether to store the image based on whether the face is present. The storage determination module 520 may cause the processor 502 to determine whether to store the image solely based on whether the face is present or based on whether the face is present in combination with additional criteria. The computer-readable medium 500 may include a storage module 530. The storage module 530 may cause the processor 502 to store or discard the image according to the determination. For example, the storage determination module 520 may cause the processor 502 to indicate to the storage module 530 whether to store the image. The storage module 530 may cause the processor 502 to store or discard the image based on the indication. Referring to FIG. 1, when executed by the processor 502, the face detection module 510 may realize the face detection engine 120; the storage determine module 520 may realize the face detection engine 120 or the storage engine 130; and the storage module 530 may realize the storage engine 130.

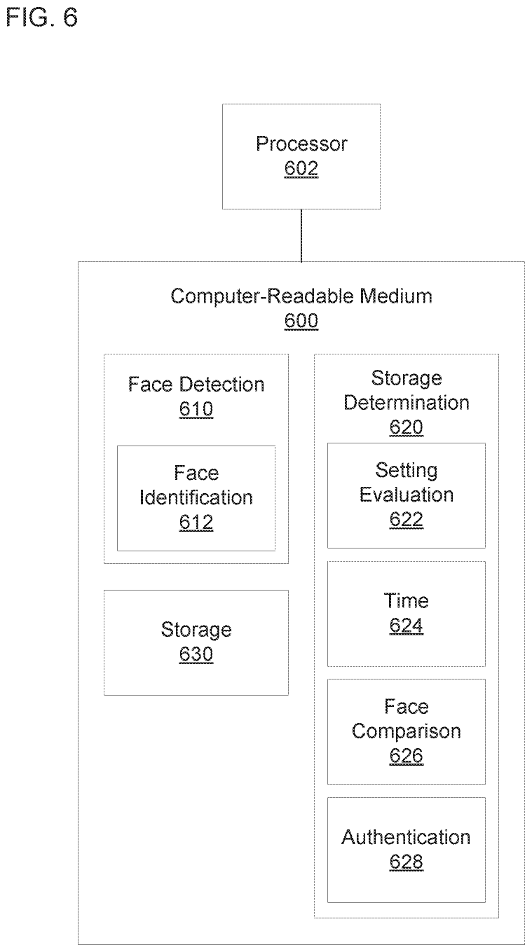

FIG. 6 is a block diagram of another example computer-readable medium 600 including instructions that, when executed by a processor 602, cause the processor 602 to store images efficiently. The computer-readable medium 600 may include a face detection module 610. The face detection module 610 may include instructions that, when executed, cause the processor 602 to determine whether the face is present in an image. For example, the face detection module 610 may cause the processor 602 to detect facial features and calculate a score indicative of whether a face is present. The face detection module 610 may cause the processor 602 to compare the score to a threshold to determine whether a face is detected.

The face detection module 610 may include a face identification module 612. The face identification module 612 may cause the processor 602 to identify a face detected in the image. For example, the face identification module 612 may cause the processor 602 to compare the face detected in the image to a plurality of stored faces (e.g., a plurality of enrolled faces). The plurality of stored faces may be stored in the compute-readable medium 600 or stored remotely. The face identification module 612 may cause the processor 602 to identify a match if the similarity between the detected face and an enrolled face exceeds a threshold.

The computer-readable medium 600 may include a storage determination module 620. The storage determination module 620 may cause the processor 602 to determine whether to store the image based on whether the face is present. For example, the storage determination module 620 may cause the processor 602 to determine that every frame containing a face should be stored, that a subset of frames containing faces should be stored (e.g., a representative frame, a plurality of representative frames, etc.), that some frames containing faces as well as some additional frames not containing faces should be stored (e.g., a frame containing a face and a related frame not containing a face), or the like. The storage determination module 620 may include a setting evaluation module 622. The setting evaluation module 622 may cause the processor 602 to evaluate a setting. For example, the setting evaluation module 622 may cause the processor 602 to determine a value of a setting, and the storage determination module 620 may cause the processor 602 to determine whether to store the image based on the setting. In an example, the storage determination module 620 may cause the processor 602 to store a representative image containing the face and discard other images containing the face (e.g., store a single representative, store a plurality of representative images, etc.). The storage determination module 620 may cause the processor 602 to store the representative image and the other images based on the setting being a second state (e.g., store every image in which a face is detected, store a plurality of representative images and a plurality of related images, etc.).

The storage determination module 620 may include a time module 624. The time module 624 may cause the processor 602 to determine whether the detected face was present in a previous image that was captured less than a threshold time before the image in which the face was detected. For example, the previous image and the image in which the face was detected may be determined to be parts of the same event if the time between the images is less than the threshold. The storage determination module 620 may cause the processor 602 to determine whether to store the image based on whether the image times are within the threshold. For example, the storage determination module 620 may cause the processor 602 to store the image in which the face was detected based on the image times being outside the threshold (e.g., the images are determined not to be part of the same event). The storage determination module 620 may cause the processor 602 to discard the image in which the face was detected based on the image times being within the threshold (e.g., the images are determined to be part of the same event). In an example, if the image times are within the threshold, the storage determination module 620 may cause the processor 602 to determine whether to discard the previous image or the image in which the face was detected based on in which image the face is more identifiable.

The storage determination module 620 may include a face comparison module 626. The face comparison module 626 may cause the processor 602 to determine whether the image in which the face was detected and the previous image contain the same number of faces. The face comparison module 626 may cause the processor 602 to determine whether the features of the faces in the image in which the face was detected and the features of the faces in the previous image are similar. The storage determination module 620 may cause the processor 602 to determine whether to store the image in which the face is detected based on whether both images contain the same number of faces or based on whether the features of the faces in the images are similar. The storage determination module 620 may cause the processor 602 to discard one of the images if the images contain the same number of faces or the faces are similar. The storage determination module 620 may cause the processor 602 to determine which image to discard based on in which image the face is more identifiable. The storage determination module 620 may cause the processor 602 to store both images if the images contain different numbers of faces or the faces are not similar. In some examples, the storage determination module 620 may include one of the time module 624 and the face comparison module 626, or the time module 624 and the face comparison module 626 may operate independently of each other.

The storage determination module 620 may include an authentication module 628. As previously discussed, the face identification module 612 may cause the processor 602 to identify a face detected in an image. In one example, the computer-readable medium 600 or a remote system can store a list (gallery) of facial features from known people (or authorized people), a list of trusted identities, a list of untrusted identities, or the like. The authentication module 628 may cause the processor 602 to compare the facial features or identity to the list to authenticate the face. If the facial feature of a person in an image matches one on the list, then that person may be admitted to a particular location. If a person's facial feature cannot be matched to any features on the list, that person may not be admitted. For example, the authentication module 628 may cause the processor 602 to send a signal to a smart lock, for example, to control the opening of a door. In an example, the computer-readable medium 600 or a remote system may store a black list, which may contain facial features of people whom law enforcement is watching. The authentication module 628 may cause the processor 602 to generate an alert if the facial features or identity of a person in an image matches the black list. The alert may be sent, for example, to law enforcement.

In some examples, the storage determination module 620 may cause the processor 602 to determine whether to store an image in which the face is detected based on whether the face is authenticated. The storage determination module 620 may cause the processor 602 to determine whether to store the image based on whether any face is authenticated, whether all faces are authenticated, whether any face is unauthenticated, whether all faces are unauthenticated, whether a threshold number or percentage of faces are authenticated or unauthenticated, or the like. In an example, the storage determination module 620 may cause the processor 602 to decide to store a representative image of a face and discard other images of the face based on the face being authenticated. In such an example, the storage determination module 620 may cause the processor 602 to decide to store the representative image of the face and the other images of the face based on the face not being authenticated. In an example, the storage determination module 620 may cause the processor 602 to decide to discard all images of the face based on the face being authenticated. In such an example, the storage determination module 620 may cause the processor 602 to decide to store a representative image of a face and discard other images of the face based on the face not being authenticated. In some examples, the storage determination module 620 may cause the processor 602 to combine the determinations by the setting evaluation module 622, the time module 624, the face comparison module 626, or the authentication module 628 to determine whether to store an image.

The computer-readable medium 600 may include a storage module 630. The storage module 630 may cause the processor 602 to store or discard an image according to the determination by the storage determination module 620 whether to store the image. The storage module 630 may cause the processor 602 to store images to a persistent computer-readable medium. The computer-readable medium 600 may include the persistent computer-readable medium, or the persistent computer-readable medium may be located remotely. The storage determination module 620 may cause the processor 602 to indicate to the storage module 630 whether to store or discard each image. In an example, the storage determination module 620 may cause the processor 602 to discard images to be discarded and to transmit or indicate to the storage module 630 images to be stored. In an example, when executed by a processor, the face detection module 610, the face identification module 612, the storage determination module 620, the setting evaluation module 622, or the authentication module 628 may realize the face detection engine 220 of FIG. 2; the storage determination module 620, the time module 624, or the face comparison module 626 may realize the event detection engine 240; and the storage module 630 may realize the storage engine 230.

The above description is illustrative of various principles and implementations of the present disclosure. Numerous variations and modifications will become apparent to those skilled in the art once the above disclosure is fully appreciated. Accordingly, the scope of the present application should be determined only by the following claims.

What is claimed is:

1. A system comprising:
an image capture engine to:
detect motion, and
based on the motion, capture an image;
a face detection engine to determine whether a face is present in the image; and
a storage engine to, based on a determination the face is present, store the image.

2. The system of claim 1, wherein the image capture engine is to capture an additional image, the face detection engine is to identify the face in the image and the additional image, and the storage engine is to discard the additional image based on the identified face being in the image and the additional image.

3. The system of claim 2, further comprising an event detection engine to determine a time between the capture of the image and the capture of the additional image, wherein the storage engine is to discard the additional image based on the identified face being in the image and the additional image and the time being less than a threshold.

4. The system of claim 2, wherein the face detection engine is to determine whether a quality of the face is better in the image or the additional image, and wherein the storage engine is to discard the additional image based on the quality of the face being better in the image.

5. The system of claim 4, wherein the face detection engine is to determine the quality of the face based on at least one selected from the group consisting of pose, angle, brightness, and sharpness.

6. A method, comprising:
detecting an event in a video stream;
selecting a representative frame for the event;
storing the representative frame and discarding other frames corresponding to the event.

7. The method of claim 6, wherein selecting the representative frame comprises selecting a frame with a most identifiable face.

8. The method of claim 7, wherein selecting the frame with a most identifiable face comprises determining a roll, pitch, and yaw of the face.

9. The method of claim 7, wherein selecting the frame with a most identifiable face comprises determining whether a facial expression is neutral and determining whether eyes are open.

10. The method of claim 6, further comprising storing a start time and an end time for the event in association with the representative frame.

11. A non-transitory computer-readable medium comprising instructions that, when executed by a processor, cause the processor to:
determine whether a face is present in an image;
determine whether to store the image based on whether the face is present; and
store or discard the image according to the determination.

12. The computer-readable medium of claim 11, further comprising instructions that cause the processor to:
evaluate a setting;
based on the setting being in a first state, store a representative image containing the face and discard other images containing the face; and
based on the setting being a second state, store the representative image and the other images.

13. The computer-readable medium of claim 11, wherein the instructions cause the processor to determine whether to store the image based on whether the face was present in a previous image that was captured less than a threshold time before the image was captured.

14. The computer-readable medium of claim 13, wherein the instructions cause the processor to determine whether to store the image based on whether the image and the previous image contain a same number of faces and based on whether features of the faces are similar.

15. The computer-readable medium of claim 11, further comprising instructions that cause the processor to:
identify the face;
authenticate the face;
based on the face being authenticated, store a representative image containing the face and discard other images containing the face; and
based on the face not being authenticated, store the representative image and the other images.
